(19) United States
(12) Patent Application Publication
(10) Pub. No.: US 2005/0260359 A1
(43) Pub. Date: Nov. 24, 2005

(54) Liquid crystal display device

(75) Inventors: Noboru Kunimatsu, Mobara (JP); Masataka Yoshizawa, Minamiashigara (JP); Setsuo Kobayashi, Mobara (JP); Junji Tanno, Mobara (JP); Shigeru Matsuyama, Mobara (JP)

Correspondence Address: REED SMITH LLP, 3110 FAIRVIEW PARK DRIVE, SUITE 1400, FALLS CHURCH, VA, 22042, US

(73) Assignee: Hitachi Displays, Ltd.

(21) Appl. No.: 10/623,615

(22) Filed: Jul. 22, 2003

(30) Foreign Application Priority Data
Jul. 23, 2002 (JP) 2002-213717

(51) Int. Cl. C09K 19/58; G02F 1/1337

(52) U.S. Cl. 428/1.4; 252/299.3; 349/123

(57) ABSTRACT

A liquid crystal display device capable of significantly suppressing an after image is provided. The liquid crystal display device contains substrates arranged as opposed to each other through a liquid crystal; a pixel electrode and a counter electrode for generating an electric field between the pixel electrode and the counter electrode, provided on a pixel region on a surface on a side of the liquid crystal of one of the substrates; and a charge transporting layer provided to cover the pixel electrode and the counter electrode, in which the pixel electrode and the counter electrode are formed in the same layer on one plane, and the liquid crystal has a resistivity of less than 1×10¹³ Ω·cm.

### BACKGROUND OF THE INVENTION

1. Field of the Invention

The present invention relates to a liquid crystal display device, and more particularly, it relates to a liquid crystal device of a so-called in-plane switching (IPS) type.

2. Description of the Related Art

A liquid crystal display device of an in-plane switching type has pixel electrodes and counter electrodes formed each on pixel region on one surface on the side of a liquid crystal of substrates arranged to face each other via the liquid crystal, and the light transmittance of the liquid crystal is controlled with an electric field generated between the electrodes.

In a device where it is applied to the active matrix system, regions on one of the substrates on the side of the liquid crystal surrounded with gate signal lines arranged in the y direction and extending in the x direction and drain signal lines arranged in the x direction extending in the y direction are used as pixel regions.

An image signal is supplied to the pixel electrode from the drain signal line on one side through a switching element, and the switching element can switch the on/off state with a scanning signal supplied from the gate signal line one side.

A normative signal with respect to the image signal is supplied to the counter electrode through, for example, a counter voltage signal.

The liquid crystal display device thus constituted has an orientation film formed on the surface of the substrate that is in direct contact with the liquid crystal, and the initial orientation direction of the liquid crystal molecules is determined by the orientation film for behaving in correspondence with the intensity of the electric field.

However, it has been pointed out that the liquid crystal display device having such a constitution is liable to accumulate electric charge in the orientation film due to the characteristics in structure thereof, and an after image is liable to occur upon displaying due to such a phenomenon.

Furthermore, in the case where a liquid crystal having a small resistivity is used, a relaxation phenomenon of a direct current (DC) voltage occurs to cause a so-called short after image in a few seconds, and in the case where a liquid crystal having a large resistivity is used, an after image due to a residual direct current (DC) voltage is formed.

### SUMMARY OF THE INVENTION

The invention has been developed based on the aforementioned circumstances, and an object thereof is to provide a liquid crystal display device having been remarkably suppressed in occurrence of an after image.

A conventional liquid crystal display device (liquid crystal cell) is used as a sample, and a direct current (DC) voltage of 1 V is applied to respective pixels thereof for 2 minutes, followed by terminating the application. The relative luminance (%) of the respective pixel is measured during the operation, and thus the graph shown in FIG. 29 is obtained.

As apparent from the figure, it is understood that relaxation of the relative luminance BL occurs during the period A where the direct current (DC) voltage is applied, and this means that a direct current component is accumulated in the liquid crystal cell.

It is also understood that in the period B where the application of the direct current voltage is terminated, the luminance is fluctuated upon terminating the application of the direct current voltage (which corresponds to the moment where the displayed image is switched), and thus the fluctuation of the luminance is recognized as an after image by the observer.

It is found from the foregoing consideration that in the process where a direct current voltage is applied to the pixels (period A), and then the application is terminated (period B), it is desired that the relative luminance BL (%) of the pixels remains substantially unchanged before and after the termination of the application of a direct current voltage as shown in FIG. 30.

The aforementioned graphs based on the experimental data have been obtained based on the following evaluation conditions.
(a) Polarizing plates are attached to both surfaces of a liquid crystal cell with crossed nicols to minimize the transmittance with no voltage application.
(b) A direct current voltage of 10 V or more is applied to the gate electrode.
(c) An alternating current voltage is applied to the signal electrode to make 50% of the maximum luminance.
(d) A direct current voltage of 1 V is overlaid on the signal electrode (2 minutes).
(e) The change in time of the illuminance of light transmitted through the liquid crystal cell is measured.

The invention has been developed based on the foregoing investigations and, for example, relates to the following embodiments.

(1) A liquid crystal display device containing substrates arranged as opposed to each other through a liquid crystal; a pixel electrode and a counter electrode for generating an electric field between the pixel electrode and the counter electrode, provided on a pixel region on a surface on a side of the liquid crystal of one of the substrates; and a charge transporting layer provided to cover the pixel electrode and the counter electrode,
the pixel electrode and the counter electrode being formed in the same layer on one plane, and the liquid crystal having a resistivity of less than 1×10¹³ Ω·cm.

(2) A liquid crystal display device as described in the item (1), wherein the charge transporting layer has a function of an orientation film.

(3) A liquid crystal display device as described in the item (2), wherein the charge transporting layer has a function of an orientation film has optical orientation property.

(4) A liquid crystal display device as described in one of the items (1) to (3), wherein a starting material for forming the charge transporting layer contains a diamine.

(5) A liquid crystal display device as described in the item (4), wherein a starting material for forming the charge transporting layer contains a phenylenediamine.

(6) A liquid crystal display device as described in the item (4), wherein a starting material for forming the charge transporting layer contains cyclobutanetetracarboxylic dianhydride and a diamine.

(7) A liquid crystal display device as described in the item (2), wherein the charge transporting layer has a resistivity that is equivalent to or smaller than a resistivity of the liquid crystal.

(8) A liquid crystal display device containing substrates arranged as opposed to each other through a liquid crystal; and a pixel electrode and a counter electrode for generating an electric field between the pixel electrode and the counter electrode formed in the same layer on one plane on a pixel region on a surface on a side of the liquid crystal of one of the substrates,
a relative flicker intensity after lapsing 120 seconds from application of a direct current voltage between the pixel electrode and the counter electrode being 40% or more of a relative flicker intensity immediately after the application of the direct current voltage.

(9) A liquid crystal display device containing substrates arranged as opposed to each other through a liquid crystal; and a pixel electrode and a counter electrode for generating an electric field between the pixel electrode and the counter electrode formed in the same layer on one plane on a pixel region on a surface on a side of the liquid crystal of one of the substrates,
an increment of luminance after lapsing 120 seconds from application of a direct current voltage between the pixel electrode and the counter electrode being 40% or more of an increment of luminance immediately after the application of the direct current voltage.

(10) A liquid crystal display device containing substrates arranged as opposed to each other through a liquid crystal; and a pixel electrode and a counter electrode for generating an electric field between the pixel electrode and the counter electrode formed in the same layer on one plane on a pixel region on a surface on a side of the liquid crystal of one of the substrates,
a relative flicker intensity after applying a direct current voltage between the pixel electrode and the counter electrode for 120 seconds, followed by terminating the application of the direct current voltage, and lapsing 2 seconds after the termination being 5% or less of a relative flicker intensity immediately after the application of the direct current voltage.

(11) A liquid crystal display device containing substrates arranged as opposed to each other through a liquid crystal; and a pixel electrode and a counter electrode for generating an electric field between the pixel electrode and the counter electrode formed in the same layer on one plane on a pixel region on a surface on a side of the liquid crystal of one of the substrates,
an increment of luminance after applying a direct current voltage between the pixel electrode and the counter electrode for 120 seconds, followed by terminating the application of the direct current voltage, and lapsing 2 seconds after the termination being 5% or less of luminance before the application of the direct current voltage.

(12) A liquid crystal display device as described in one of the items (8) to (11), wherein the liquid crystal display device further contains a charge transporting layer formed to cover the pixel electrode and the counter electrode.

(13) A liquid crystal display device as described in one of the items (8) to (11), wherein the liquid crystal has a resistivity of less than 1×10¹³ Ω·cm.

(14) A liquid crystal display device as described in the item (12), wherein the charge transporting layer has a function of an orientation film.

(15) A liquid crystal display device as described in the item (14), wherein the charge transporting layer is formed to cover directly the pixel electrode and the counter electrode.

(16) A liquid crystal display device as described in the item (15), wherein a starting material for forming the charge transporting layer contains a phenylenediamine.

(17) A liquid crystal display device as described in the item (15), wherein a starting material for forming the charge transporting layer contains cyclobutanetetracarboxylic dianhydride and a phenylenediamine as major components.

(18) A liquid crystal display device as described in the item (2), wherein the charge transporting layer contains the structure represented by the following general formula (3).

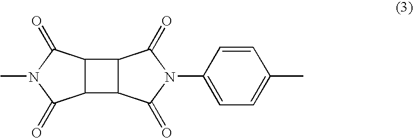

(19) A liquid crystal display device as described in one of the items (8) to (13), wherein the charge transporting layer contains the structure represented by the following general formula (4).

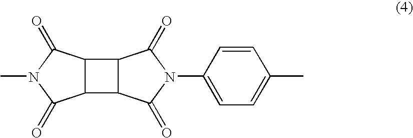

(20) A liquid crystal display device as described in one of the items (1) to (19), wherein the charge transporting layer has optical orientation property.

The invention is not construed as being limited to the aforementioned embodiments, and various changes may be made therein unless they deviate from the sprit and the technical concept of the invention.

### BRIEF DESCRIPTION OF THE DRAWINGS

FIG. 1 is a plane view showing an example of a pixel of a liquid crystal display device according to the invention.

FIG. 2 is a cross sectional view on line II-II in FIG. 1.

FIG. 3 is a cross sectional view on line III-III in FIG. 1.

FIG. 4 is a cross sectional view on line IV-IV in FIG. 1.

FIG. 5 is a cross sectional view on line V-V in FIG. 1.

FIG. 6 is a plane view intelligibly showing patterns of an upper layer pixel electrode PX, a counter electrode CT and a counter electrode connecting line CPT of the pixel.

FIG. 7 is a plane view intelligibly showing a pattern of a lower pixel electrode PXM of the pixel.

FIG. 8 is an explanatory view clarifying the effect of the liquid crystal display device according to the invention.

FIG. 9 is an explanatory view showing a problem occurring in a conventional liquid crystal display device.

FIG. 10 is molecular structural formulae showing a material containing a diamine structure.

FIGS. 11A to 11G are molecular structural formulae showing material containing diamine structure.

FIG. 12A is a molecular structural formula showing phenylenediamine and FIG. 12B is a molecular structural formula showing cyclobutanetetracarboxylic dianhydride.

FIG. 13 is a molecular structural formula showing a charge transporting layer containing cyclobutanetetracarboxylic dianhydride and phenylenediamine after imidation.

FIGS. 14A to 14C are diagrams showing connecting states of respective orientation films.

FIG. 15 is a molecular structural formula of a structure formed by linking two of the molecular structures shown in FIG. 13.

FIGS. 16A and 16B are molecular structural formulae of comparative material layers for showing the effect of the charge transporting layer used in the invention.

FIGS. 17A to 17C are graphs showing the status of occurrence of flickers in a liquid crystal display part upon applying a direct current (DC) voltage between a pixel electrode and a counter electrode.

FIGS. 18A and 18B are molecular structural formulae showing other examples of the charge transporting layer used in the invention.

FIGS. 19A and 19B are graphs showing characteristics necessary for suppressing an after image as a comparison with the conventional case.

FIGS. 20A to 20C are graphs showing transition characteristics of a relative flicker intensity with respect to time.

FIGS. 21A to 21C are graphs showing transition characteristics of a relative luminance with respect to time.

FIGS. 22A to 22C are enlarged views of a part of FIGS. 21A to 21C, respectively.

FIGS. 23A to 23C are enlarged views of a part of FIGS. 20A to 20C, respectively.

FIG. 24 is a graph showing the relationship of the relative luminance with respect to the resistivity of the liquid crystal of the respective orientation films.

FIG. 25 is a graph showing the relationship of the relative flicker intensity with respect to the resistivity of the liquid crystal of the respective orientation films.

FIGS. 26A to 26C are enlarged views of a part of FIGS. 20A to 20C, respectively.

FIGS. 27A to 27C are enlarged views of a part of FIGS. 21A to 21C, respectively.

FIG. 28 is a graph showing the dependency of the relative luminance on the resistivity of the liquid crystal after lapsing 2 seconds from the termination of application of a direct current voltage on the respective orientation films.

FIG. 29 is a graph showing relative luminance characteristics measured with a conventional liquid crystal cell as a sample.

FIG. 30 is a graph showing relative luminance characteristics of a liquid crystal cell required in the invention.

### DESCRIPTION OF THE PREFERRED EMBODIMENTS

Embodiments of the liquid crystal display device according to the invention will be described below with reference to the drawings.

Constitution of Pixel

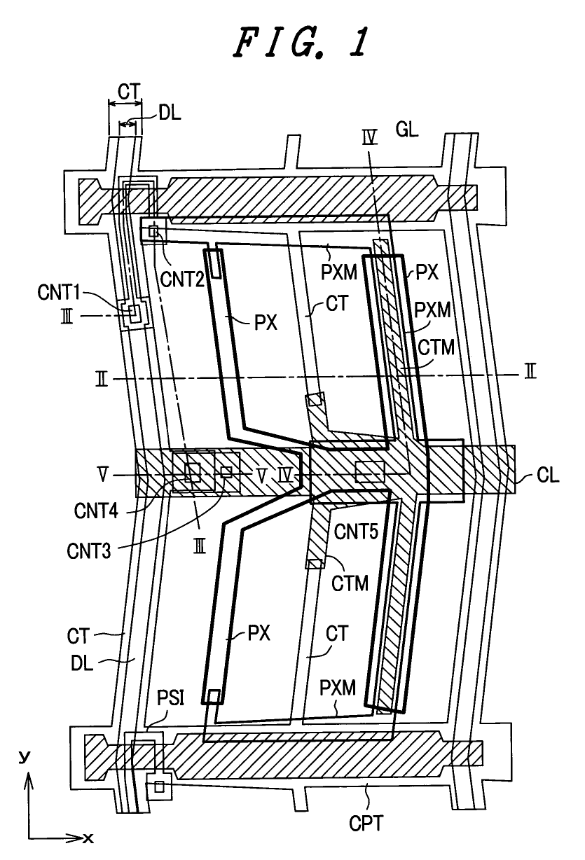

FIG. 1 is a plane view showing an example of a pixel of a liquid crystal display device according to the invention.

The liquid crystal display device according to the invention has pixel regions as regions on one of the substrates arranged as opposed to each other through the liquid crystal on the side of the liquid crystal surrounded with gate signal lines arranged in the y direction and extending in the x direction and drain signal lines arranged in the x direction extending in the y direction.

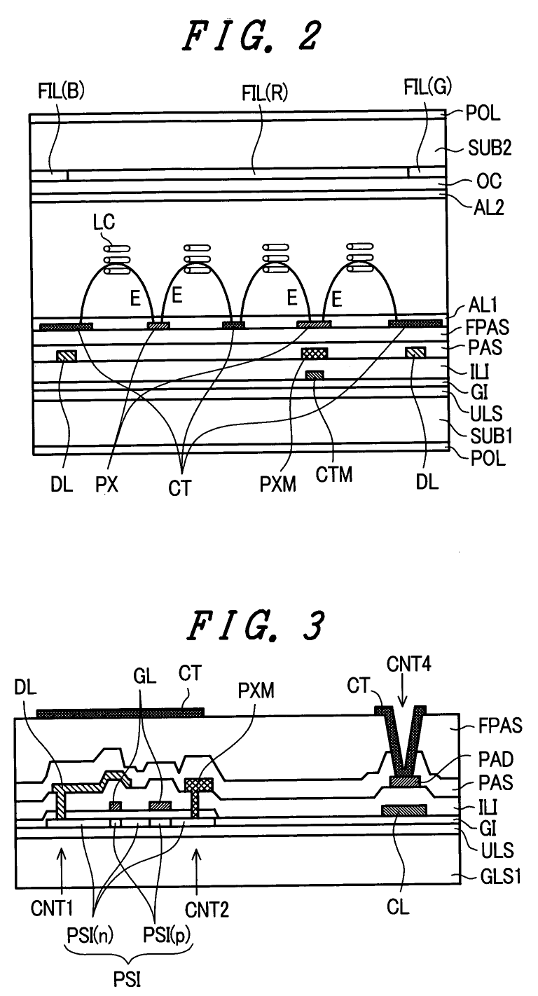

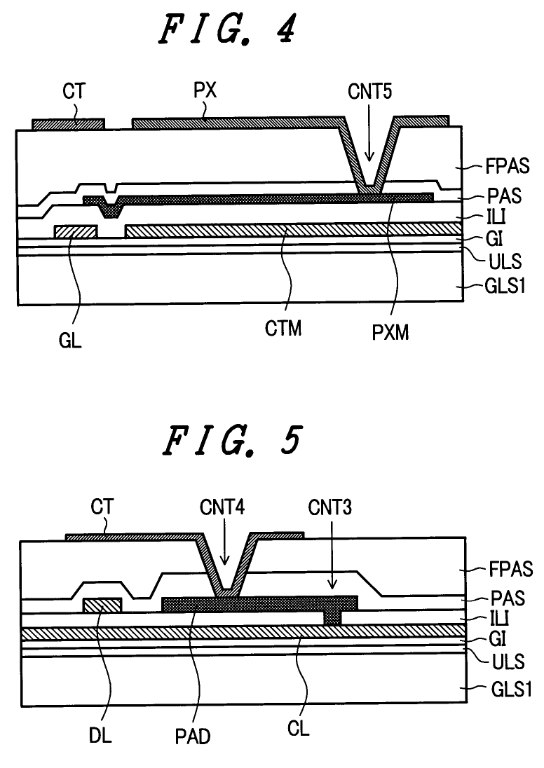

A cross sectional view on line II-II in FIG. 1 is shown in FIG. 2, a cross sectional view on line III-III is shown in FIG. 3, a cross sectional view on line IV-IV is shown in FIG. 4, and a cross sectional view on line V-V is shown in FIG. 5.

In the figures, an underlayer ULS formed, for example, with SiO₂ or SiN is provided on the surface of a transparent substrate SUB1 on the side of the liquid crystal. The underlayer ULS is formed to prevent affection of ionic impurities contained in the transparent substrate SUB1 on a thin film transistor TFT described later.

A polycrystalline silicon layer PSI to become a semiconductor layer of the thin film transistor TFT is formed on the surface of the underlayer. The polycrystalline silicon layer PSI is formed, for example, on an upper left side of the pixel region in an approximately U-shaped pattern intersecting twice a gate signal line GL described later and extending in the running direction of a drain signal line DL described later.

A first insulating film GI formed, for example, with SiO₂ or SiN is formed on the surface of the underlayer ULS having the polycrystalline silicon layer PSI to cover the polycrystalline silicon layer PSI. The first insulating film GI functions as a gate insulating film of the thin film transistor TFT.

The gate signal line GL arranged in the y direction and extending in the x direction is formed on the surface of the first insulating film GI. The gate signal line GL in this case is arranged to intersect twice the polycrystalline silicon layer PSI, and the overlapping parts with the polycrystalline silicon layer PSI function as gate electrodes of the thin film transistor.

After forming the gate signal line GL, the polycrystalline silicon layer PSI is doped with an n⁺ type impurity of a high concentration with the gate signal line GL, more specifically the gate electrodes, used as a mask, so as to be imparted with electroconductivity in regions except for directly below the gate electrodes as shown in the cross sectional view in FIG. 3.

Between a pair of the gate signal lines GL discriminating the pixel regions, a counter voltage signal line CL is formed in parallel to the gate signal lines GL. The counter voltage signal line CL is formed, for example, with the same material as the gate signal line GL.

The counter voltage signal line CL forms extending parts CTM from the respective edges side of the counter voltage signal line CL to overlap one pixel electrode PX (on the right in the figure) of two pixel electrodes PX described later, and the extending parts CTM extend to approach the gate signal lines GL, respectively.

The counter voltage signal line CL also forms small extending parts CTM from the respective edges side of the counter voltage signal line CL at an approximately central part between the two pixel electrodes PX.

A second insulating film ILI formed, for example, with SiO₂ or SiN is formed on the surface of the first insulating film GI to cover the gate signal line GL and the counter voltage signal line CL.

A drain signal line DL arranged in the x direction and extending in the y direction is formed on the surface of the second insulating film ILI. The drain signal line DL is formed to overlap a part of the polycrystalline silicon layer PSI and is in contact with an end thereof through a contact hole CNT1.

The polycrystalline silicon layer PSI connected to the drain signal line DL forms a drain region of the thin film transistor TFT.

A lower layer pixel electrode PXM connected to the other end of the polycrystalline silicon layer PSI through a contact hole CNT2 is formed on the surface of the second insulating film ILI. The polycrystalline silicon layer PSI connected to the lower layer pixel electrode PXM forms a source region of the thin film transistor TFT.

The upper layer pixel electrode PX, the counter electrode CT and the counter electrode connecting line CPT are intelligibly shown in FIG. 6 to clarify the relationship to the pattern of the upper layer pixel electrode PX described later.

A pad part PAD is formed as an upper layer of the counter voltage signal line CL to circumvent the region where the lower layer pixel electrode PXM is formed, and the pad part PAD is electrically connected to the counter voltage signal line CL through a contact hole CNT formed in the second insulating film ILI.

The pad part PAD is formed simultaneously with the formation of the lower layer pixel electrode PXM and is connected to a counter electrode CT described later.

The lower layer pixel electrode PXM constitutes a pixel electrode for one pixel region along with the upper layer pixel electrode PX described later, and the most part thereof is formed to overlap the extending part CTM of the counter voltage signal line CL.

In other words, the lower layer pixel electrode PXM has such an approximately U-shaped pattern that extends from the source region of the thin film transistor TFT along one of the gate signal lines GL adjacent it, runs to overlap the extending part CTM of the counter voltage signal line CL, and extends along the other one of the gate signal lines GL.

At the part of the lower layer pixel electrode PXM intersecting the counter voltage signal line CL, a part having a relatively large area extending in the running direction of counter voltage signal line CL is formed to constitute a part of a capacitor element Cstg in this part.

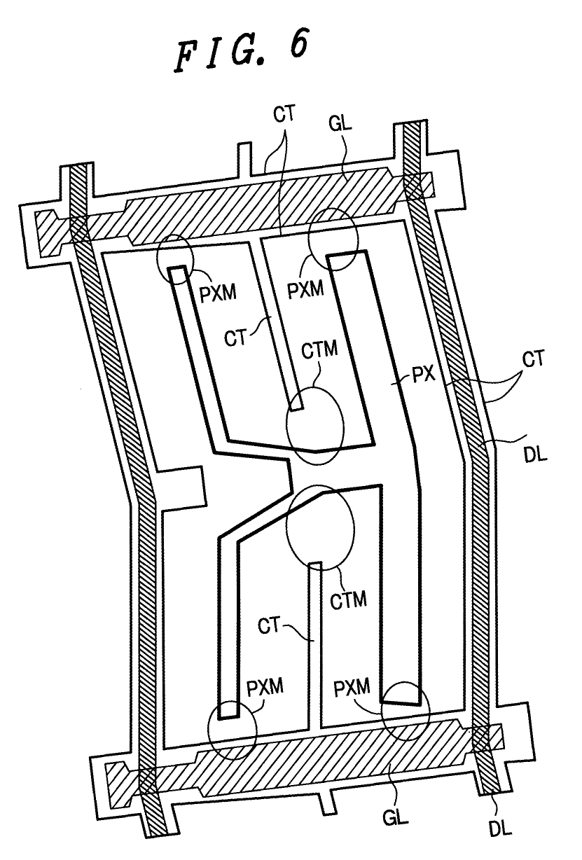

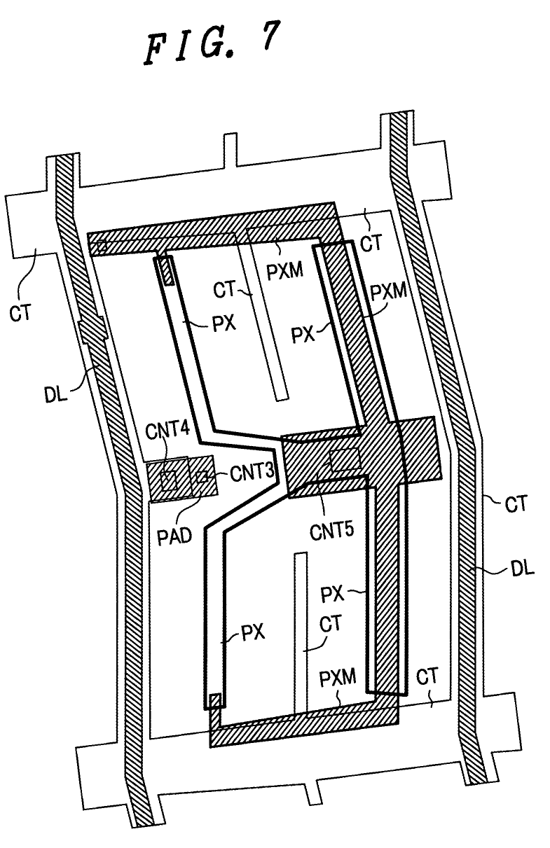

The lower layer pixel electrode PXM and the pattern of the pad part PAD are intelligibly shown in FIG. 7, as well as the positional relationship thereof with respect to the upper layer pixel electrode PX described later.

An accumulated body of a first protective film PAS formed, for example, with SiO₂ or SiN and a second protective film FPAS formed with a resin or the like is formed on the surface of the second insulating film ILI to cover the drain signal line DL and the lower layer pixel electrode PXM.

The upper layer pixel electrode PX, the counter electrode CT and the counter electrode connecting line CPT are formed with a transparent material layer, such as ITO (indium tin oxide), ITZO (indium tin zinc oxide), IZO (indium zinc oxide), SnO₂ (tin oxide) and In₂O₃ (indium oxide), on the surface of the second protective layer FPAS. The so-called aperture ratio of the pixel can be improved by using the transparent material layer.

Two pieces, for example, of the upper layer pixel electrodes PX arranged in parallel in the x direction and extending in the y direction are provided in the pixel region, and they are electrically connected to each other at the position above the counter voltage signal line CL.

One upper layer pixel electrode PX (on the right in the figure) among the upper layer pixel electrodes PX is formed to overlap the lower layer pixel electrode PXM.

The connecting part of the upper layer pixel electrode PX above the counter voltage signal line CL is connected to the lower layer pixel electrode PXM through a contact hole CNT5 penetrating the second protective film FPAS and the first protective film PAS. According to the configuration, the upper layer pixel electrode PX is also electrically connected to the source region of the thin film transistor TFT through the lower layer pixel electrode PXM.

Three pieces, for example, of the counter electrodes CT are provided with the upper layer pixel electrodes PX intervened among them, and they extend in the y direction in the figure.

One of the counter electrodes CT runs in the central part of the pixel region, and other two of them run to overlap the drain signal lines DL.

The counter electrodes CL formed to overlap the drain signal lines DL have substantially the same central axes as the drain signal lines DL and a larger width than the width of the drain signal lines DL. According to the configuration, the electric field formed by the image signal supplied from the drain signal lines DL is terminated by the counter electrodes formed to overlap the drain signal lines DL. Therefore, the electric field caused by the drain signal lines DL can be prevented from being terminated as noise in the lower layer pixel electrode PXM and the upper layer pixel electrodes PX.

One counter electrode CT among the counter electrodes CT formed to overlap the drain signal lines DL has an extending part on the counter voltage signal line CL, and the extending part is connected to the pad part PAD through a contact hole CNT4 penetrating the second protective film FPAS and the first protective film PAS. According to the configuration, the counter electrode CT is electrically connected to the counter voltage signal line CL through the pad part PAD.

The counter electrode CT running in the central part of the pixel region is separated from the counter voltage signal line CL at the intersecting part thereof, and an end of the separated part is positioned to overlap the end of the extending part CTM of the counter voltage signal line CL.

The counter electrode connecting line CPT is formed to overlap the gate signal line GL in such a manner that the central axis thereof is approximately agree with the central axis of the gate signal line GL, and the width thereof is larger than that of the gate signal line GL.

According to the configuration, an electric field formed by the scanning signal supplied from the gate signal line GL is terminated in the counter electrode connecting line CPT formed to overlap the gate signal line GL. Therefore, the electric field caused by the gate signal lines GL can be prevented from being terminated as noise in the lower layer pixel electrode PXM and the upper layer pixel electrodes PX.

The counter electrode connecting line CPT is formed integrally with the counter electrodes CT, i.e., formed so as to be electrically connected with them. According to the configuration, the overall resistance value of the counter voltage signal line CL, the counter electrode connecting line CPT and the counter electrodes CT can be significantly decreased to suppress the waveform distortion of the counter electrode signal supplied from the counter voltage signal line CL.

On the surface of the second protective film FPAS having the upper layer pixel electrode PX, the counter electrodes CT and the counter electrode connecting line CPT formed thereon, an orientation film AL1 is formed to cover the upper layer pixel electrode PX, the counter electrodes CT and the counter electrode connecting line CPT, as shown in FIG. 2. The orientation film AL1 is formed with a film that is in direct contact with the liquid crystal LC to determine the initial orientation direction of molecules of the liquid crystal LC.

The orientation film AL1 has a resistivity that is 1×10¹² Ω·cm or less of the resistivity of the liquid crystal LC, so as to have a function as a charge transporting layer in which upon charging the orientation film AL1 with an electric charge, the electric charge is liable to be dispersed.

As shown in FIG. 2, furthermore, a color filter FIL, a planarizing film OC and an orientation film AL2 are sequentially formed on the surface of the transparent substrate SUB2 that is arranged to oppose to the transparent substrate SUB1 having the foregoing configuration through the liquid crystal LC. The resistivity of the orientation film AL2 is not particularly limited in this embodiment and may be equivalent to the resistivity of the orientation film AL1.

Effect

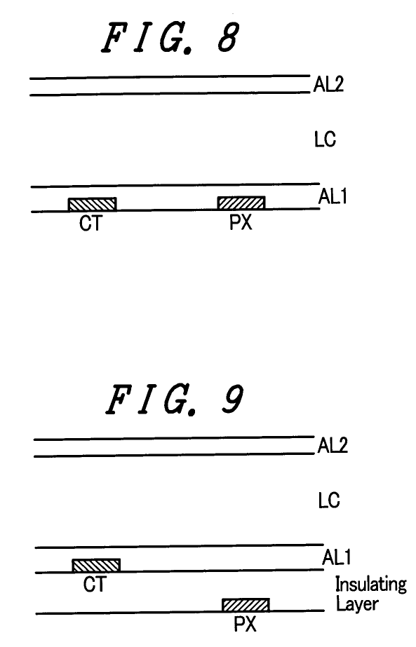

In the pixel thus constructed as shown in FIG. 8, the counter electrode CT and the upper layer pixel electrode PX are formed in the same layer on one plane, and the orientation film AL1 having a function as a direct charge transporting layer is further formed thereon.

According to the configuration, the orientation layer AL1 is the only layer that intervenes between the liquid crystal layer LC and the electrodes. In this case, when the resistivity of the orientation film AL1 is set smaller than the resistivity of the liquid crystal layer LC, the orientation film AL1 functions as a charge transporting layer. Even when a direct current is applied between the counter electrode CT and the upper layer pixel electrode PX, the direct current charge is dispersed through the alignment film AL1, and thus the entire orientation film AL1 is isoelectric to avoid the influence thereof on the liquid crystal layer LC.

The formation of an after image upon influence of a direct current is a phenomenon occurring over 1 second or more. On the other hand, the alternating current electric field between the counter electrode CT and the upper layer pixel electrode PX applied on the liquid crystal is generally a phenomenon based on a frequency of about 60 Hz, i.e., over several tens milliseconds, and therefore, it is at least two orders of magnitude faster than the phenomenon of an after image caused by a dielectric current.

Accordingly, even when the orientation film AL1 has a charge transporting capability, leakage of voltage hardly occurs between the counter electrode CT and the upper layer pixel electrode PX over several tens milliseconds, and therefore, influence on the driving voltage can be ignored, but only the effect of suppressing an after image can be obtained.

In order to obtain such effects, it is important that no another layer intervenes between the counter electrode CT and the upper layer pixel electrode PX. In the case shown in FIG. 9 where an insulating layer intervenes between them, the influence of the electric field is effected between the counter electrode CT and the upper layer pixel electrode PX due to accumulation of electric charge in the insulating layer, so as to cause an after image.

Charge Transporting Layer

The charge transporting layer of the embodiment has the function of the alignment film AL1, and the layer has the following characteristics.

(1) The resistivity of the layer is lower than that of the liquid crystal layer LC. According to the configuration, the direct current electric charge is uniformly dispersed in the charge transporting layer, and thus electrical influence on the liquid crystal layer can be prevented.

(2) The layer is formed with a material having a large amount of polar groups. A material excellent in conductivity of a direct current is suitably used for dispersing the direct current electric charge in the charge transporting layer.

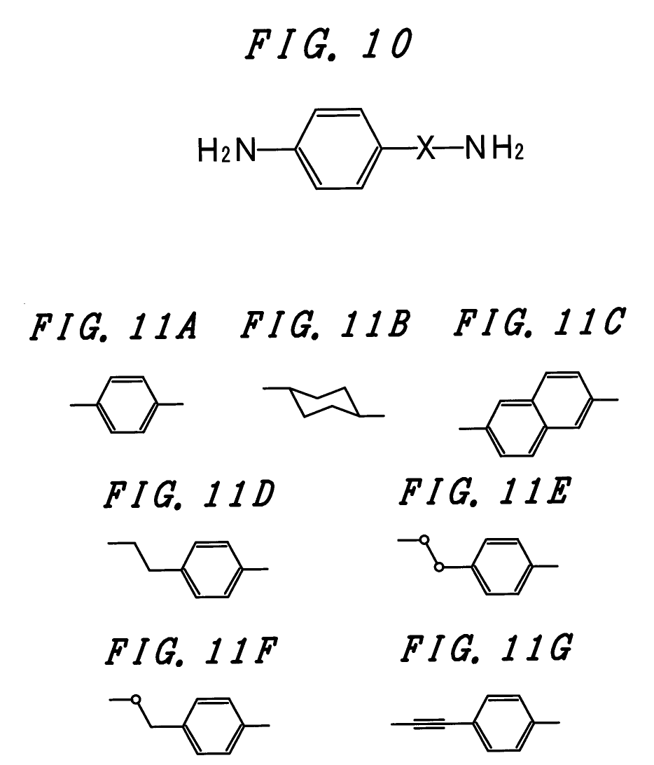

In order to attain the characteristics, a charge transporting layer containing a diamine structure as shown in FIG. 10 and FIGS. 11A to 11G as a starting material is suitable.

FIG. 10 shows a general structure of a diamine, and the group represented by x therein can be replaced by the molecular structures represented by FIG. 11A to FIG. 11G. The hydrogen atoms on the benzene ring may be substituted with a substitutable group, such as an alkyl group, an alkoxy group, a halogen atom, a cyano group and a nitro group. The group represented by x may be a single bond.

The material of the charge transporting layer has the foregoing diamine structure, and thus the so-called hopping conduction of electrons is liable to occur, and the direct current electric charge is uniformly dispersed by the hopping conduction. In other words, the direct current electric charge is uniformly dispersed toward the stable state.

The hopping conduction also has such characteristics that the time constant thereof is larger than electronic conduction. Therefore, it has such characteristics that leakage is difficult to occur for the ordinary alternating current electric field. This is because the polarity of the ordinary alternating current electric field changes by several tens milliseconds, and the hopping conduction cannot sufficiently follow the change in polarity.

Therefore, it exhibits the prominent characteristics that only electric charge caused by the direct current component can be dispersed.

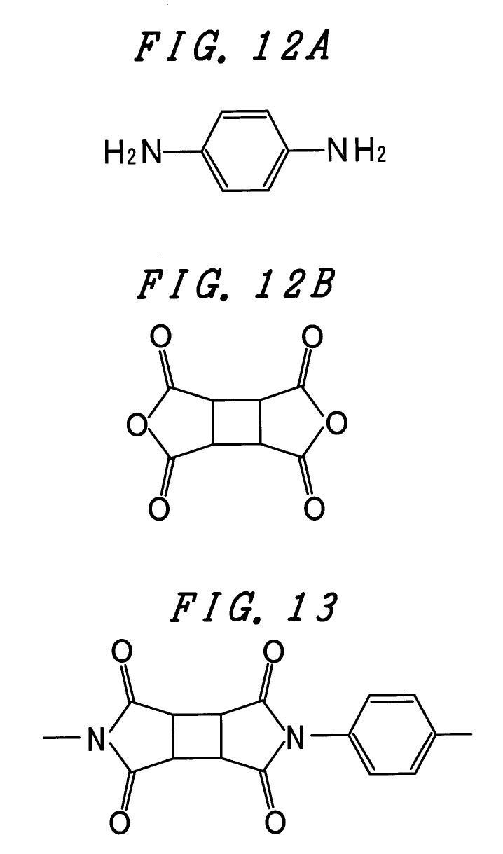

The molecular structure of the diamine where x is a single bond, i.e., phenylenediamine, is shown in FIG. 12A, and the use thereof provides amore favorable results.

This is because the proportion of the polar groups, i.e., the NH₂ groups, in the molecule can be increased to facilitate the hopping conduction, and thus the period of time required for dispersing the direct current is further suppressed.

Moreover, it is preferred to use cyclobutanetetracarboxylic dianhydride represented by the structural formula shown in FIG. 12B as a starting material of the charge transporting layer.

A molecular structure of the repeating unit of the major component of the charge transporting layer using phenylenediamine and cyclobutanetetracarboxylic dianhydride as starting materials is shown in FIG. 13. The charge transporting layer is constituted, after imidation, with a polymer represented by the structural formula shown in FIG. 15, in which plural repeating units shown in FIG. 13 are connected.

In terms of the monomers constituting the polymer, phenylenediamine is used as a diamine monomer, and cyclobutanetetracarboxylic anhydride is used as a tetracarboxylic dianhydride monomer.

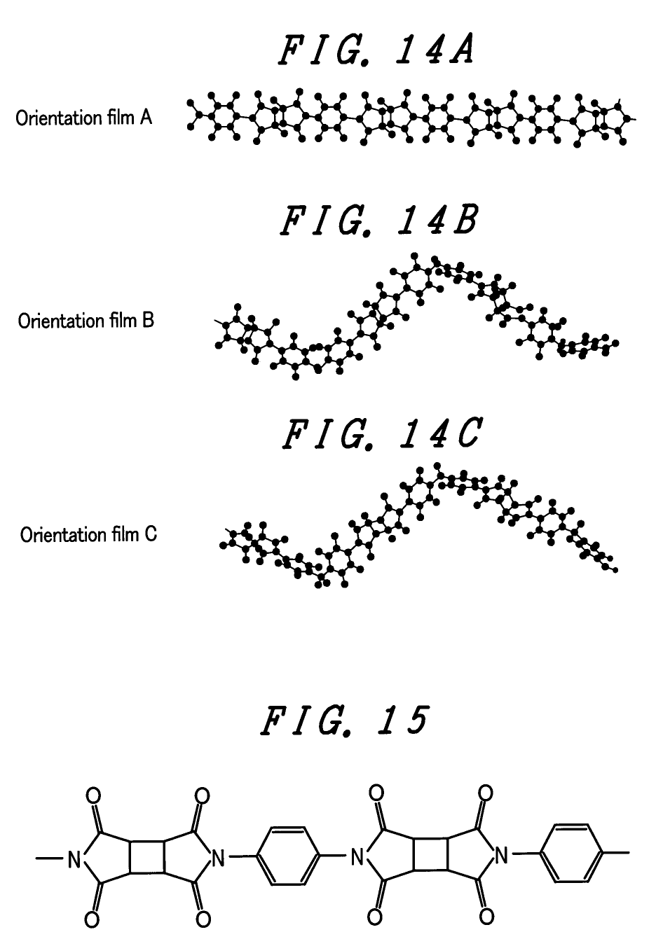

The main chain of the charge transporting layer has a linear structure owing to the molecular structure of the charge transporting layer, whereby the hopping conduction is further facilitated. That the main chain of the charge transporting layer has a linear structure means the orientation film A shown in FIG. 14A, which can be clearly distinguished from the orientation films B and C shown in FIGS. 14B and 14C.

Discussion 1

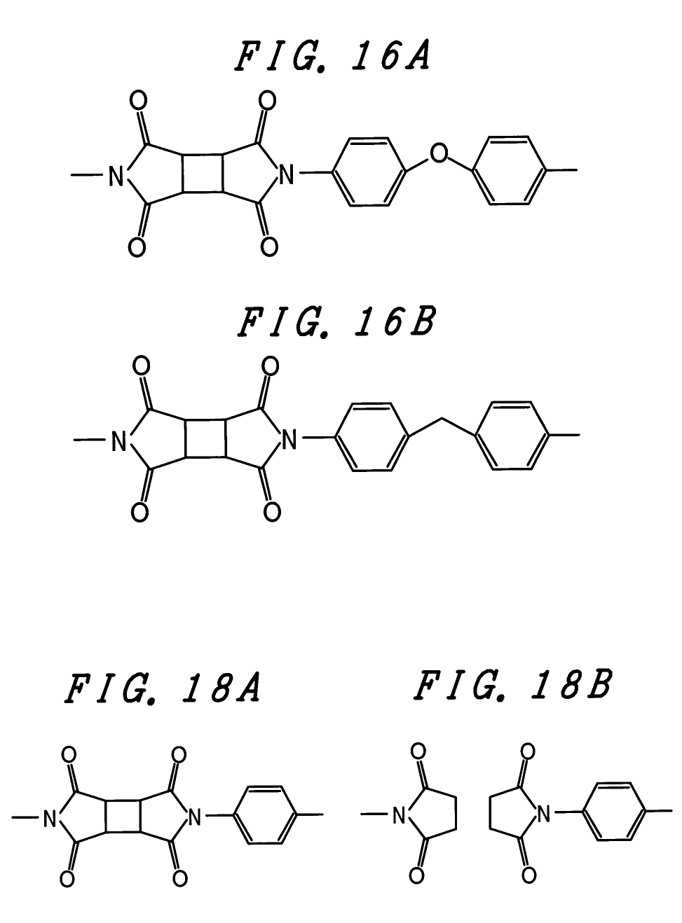

The charge transporting layer A having the molecular structure shown in FIG. 13 will be compared to the material layer B having the molecular structure shown in FIG. 16A and the material layer C having the molecular structure shown in FIG. 16B.

In the experiment, the charge transporting layer A, the material layer B and the material layer C are used as the material for the orientation film AL1. Therefore, hereinafter, the charge transporting layer A is referred to as an orientation film A, the material layer B is referred to as an orientation film B, and the material layer C is referred to as an orientation film C.

The names of the starting materials of the orientation film B are diamino diphenyl ether as a diamine monomer, and cyclobutanetetracarboxylic dianhydride as a tetracarboxylic dianhydride monomer, and those of the orientation film C are diaminodiphenylmethane as a diamine monomer, and cyclobutanetetracarboxylic dianhydride as a tetracarboxylic dianhydride monomer.

It is understood herein that the orientation films B and C are decreased in the proportion of the polar groups and also decreased in the linearity of the structure, as compared to the orientation film A.

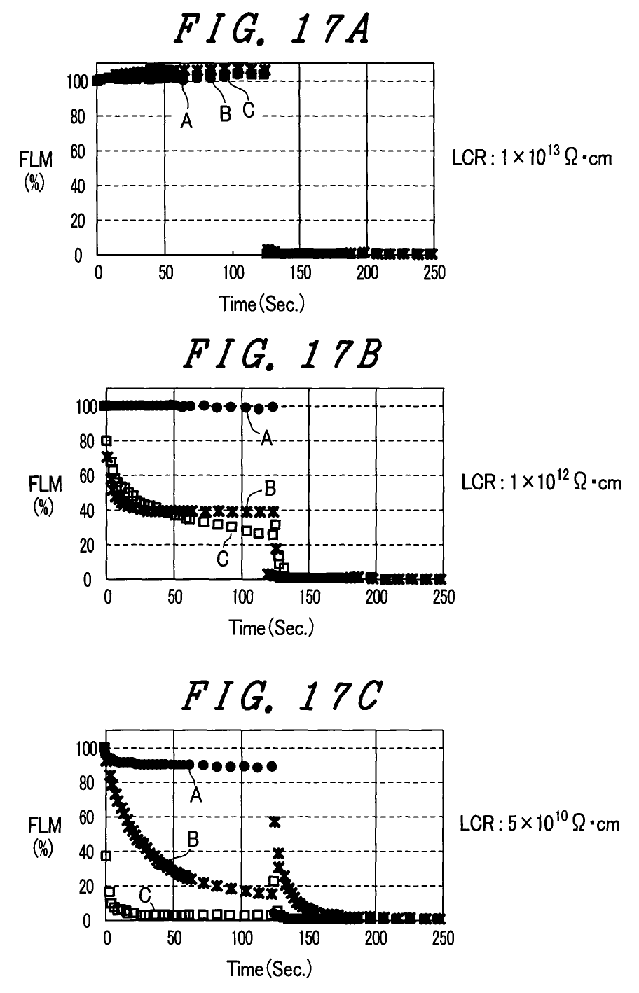

FIGS. 17A to 17C show the status of occurrence of flickers in the liquid crystal display part upon applying a direct current (DC) voltage between the pixel electrode PX and the counter electrode CT.

Specifically, under the state where the device is driven with an alternating current to become luminance of 50% for each pixel, a direct current voltage of 1 V is applied to a period of from 0 to 120 seconds. After lapsing 120 seconds, the application of the direct current is terminated, and the change of the flickers is observed and shown in the figures.

The graph shown in FIG. 17A is the case where the liquid crystal has a resistivity of 1×10¹³ Ω·cm, that shown in FIG. 17B is the case where the liquid crystal has a resistivity of 1×10¹² Ω·cm, and that shown in FIG. 17C is the case where the liquid crystal has a resistivity of 1×10¹⁰ Ω·cm.

The characteristic curves A, B and C in FIGS. 17A to 17C show the cases where the orientation films A, B and C are used as the material of the orientation film AL1, respectively.

As seen from the figures, in the case where the resistivity LCR of the liquid crystal is high as in FIG. 17A, all the orientation films A, B and C can be favorably used. However, as the resistivity LCR of the liquid crystal is decreased as the cases of from FIGS. 17B to 17C, the dielectric current electric charge uprises on the side of the liquid crystal layer due to the insufficient hopping conduction in the orientation films B and C, which are inferior in linearity, so as to make affection on the liquid crystal layer, and as a result, uprush of flickers is observed after terminating the application of the direct current (DC) voltage due to occurrence of a relaxation phenomenon of the direct current.

Therefore, it is understood that the linearity of the orientation film is important in the case where the resistivity LCR of the liquid crystal is as low as 1×10¹² Ω·cm or less.

Discussion 2

While an orientation film AL1 having high linearity, such as the orientation film A, can be suppressed in occurrence of an after image, it has been found that the orientation film AL1 becomes stiff as a compensation of the high linearity.

It has been therefore found that the orientation treatment applied to such an orientation film AL1 requires a prolonged period of time. Furthermore, brittleness occurs associated with the stiffness, and it has also been found that cut dusts are liable to be formed upon a rubbing treatment of the orientation film, and a washing process is necessarily added for removing them.

Under the circumstances, optical orientation is employed in this embodiment as a suitable treatment method for the stiff orientation film AL1.

That is, the orientation treatment is carried out by irradiation with a polarized UV light instead of the rubbing treatment.

As a result of the optical orientation treatment, the bond of the material of the orientation film A extending in the polarization direction shown in FIG. 18A is cut by the photoenergy to form a structure having a separated part as shown in FIG. 18B. Because no breakage occurs in the direction perpendicular to the polarization direction, orientation is formed in the direction perpendicular to the polarization direction.

Double bonds are formed at the separated part to generate π electron cloud, which further facilitates the hopping conduction of electrons. Therefore, such a structure is obtained that is further suppressed in occurrence of an after image in comparison to the case of the rubbing treatment.

In this case, a heat treatment may be carried out during the light irradiation of the orientation film A. This is because a part of the separated part thus broken is transferred into a stable state by bonding with other molecules due to heat energy, and thus the free motion of the molecular end is suppressed to improve the orientation property. Furthermore, because there is no case where all the separated parts are bonded to other molecules, the effect of facilitating the hopping conduction owing to the formation of π electron cloud can be still maintained.

It has also found that the orientation film A is liable to exhibit the orientation property by the optical orientation treatment owing to the excellent linearity thereof. Furthermore, a tilt angle is difficult to occur owing to the excellent linearity, and thus some artifices are required for applying to the so-called twist nematic (TN) system. However, it has been found that such a property is rather advantageous in the IPS system, i.e., the constitution of the foregoing pixel requiring no tilt angle, so as to attain further enhancement of the viewing angle.

Discussion 3

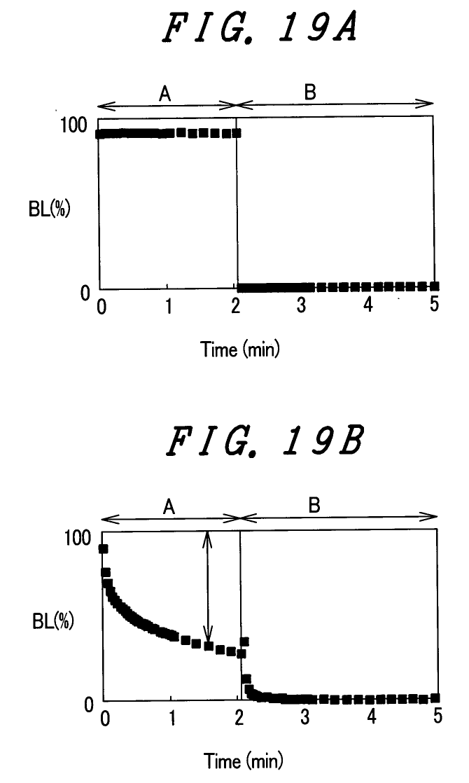

It is apparent that the feature that required for suppressing an after image as in this embodiment resides in the characteristics shown in FIG. 19B but the characteristics shown in FIG. 19A.

A method for quantitative evaluation and demonstration of the characteristics will be described below.

The measurement is carried out by the following manner.

(1) The device is driven with an alternating current voltage corresponding to a luminance of 50% for each pixel.

(2) A direct current voltage of 1 V is overlaid on the alternating current voltage corresponding to a luminance of 50% (the device is continuously driven for 120 seconds in this case) to drive the device.

(3) The device is then driven with an alternating current voltage corresponding to a luminance of 50% for each pixel.

That is, a direct current of 1 V is applied only for 120 seconds, and the transition characteristics of flickers and luminance are measured by using a luminance meter.

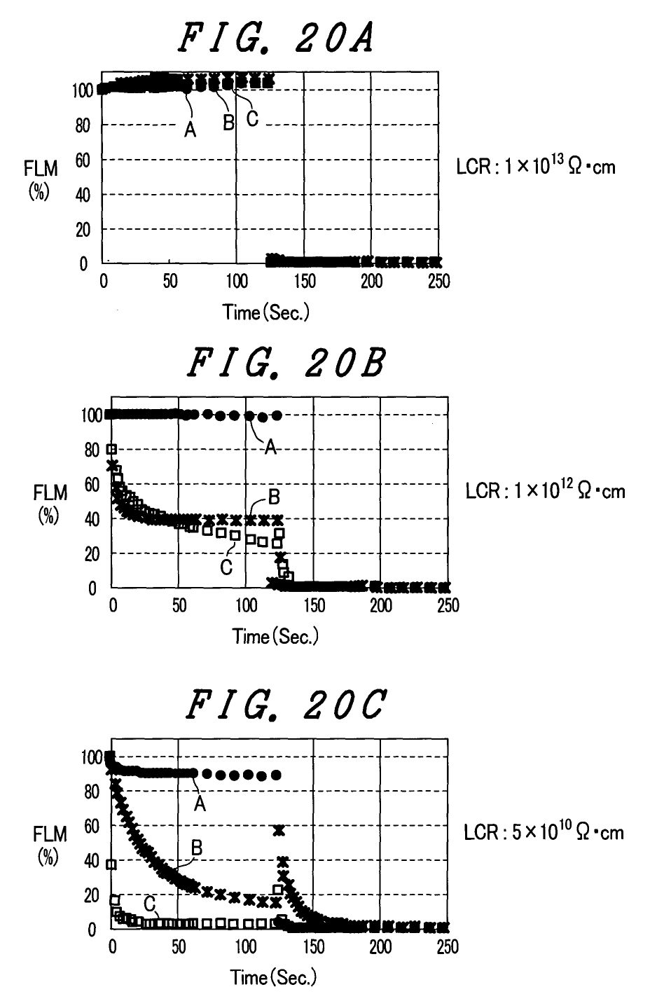

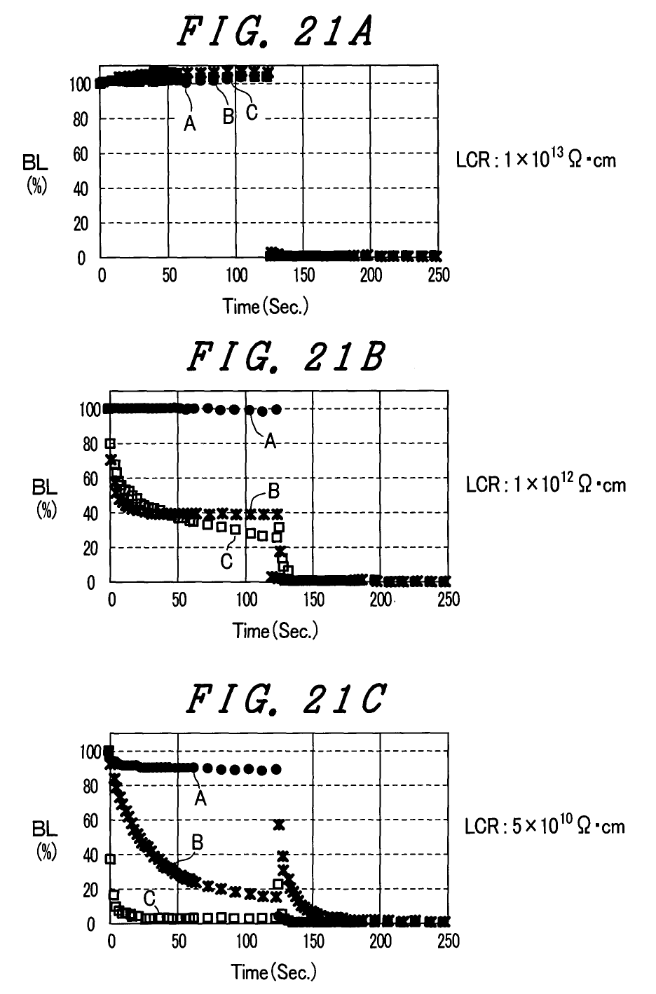

As a result of the evaluation, the transition characteristics of flickers and the transition characteristics of relative luminance are obtained as shown in FIGS. 20A to 20C and 21A to 21C.

In FIGS. 20A to 20C showing the transition characteristics of flickers, liquid crystals each having resistivity of 1×10¹³ Ω·cm, 1×10¹² Ω·cm or 5×10¹⁰ Ω·cm are used, respectively. In the figures, the abscissa indicates the time (second), and the ordinate indicates the relative flicker intensity (%).

The characteristic curves A, B and C in the figures show the cases where the orientation films A, B and C are used, respectively.

It is understood from the figures that no problem occurs in the case where the resistivity of the liquid crystal is 1×10¹³ Ω·cm, but in the case where the resistivity of the liquid crystal is smaller than that value, relaxation in the relative flicker intensity occurs for those using the orientation films B and C, whereas no relaxation occurs for that using the orientation film A.

In FIGS. 21A to 21C showing the transition characteristics of relative luminance, liquid crystals each having resistivity of 1×10¹³ Ω·cm, 1×10¹² Ω·cm or 5×10¹⁰ Ω·cm are used, respectively. In the figures, the abscissa indicates the time (second), and the ordinate indicates the relative luminance (%).

The characteristic curves A, B and C in the figures show the cases where the orientation films A, B and C are used, respectively.

It is understood from the figures that no problem occurs in the case where the resistivity of the liquid crystal is 1×10¹³ Ω·cm, but in the case where the resistivity of the liquid crystal is smaller than that value, relaxation in the relative luminance occurs for those using the orientation films B and C, whereas no relaxation occurs for that using the orientation film A.

The data obtained herein are analyzed by at least one of the four methods described below.

(1) Change in Luminance upon Application of Direct Current

In this method, the susceptibility in relaxation of a direct current (DC) voltage is measured to evaluate the susceptibility in accumulation of a direct current (DC) voltage. The measured data is fitted with the following exponential equation (1) (which can be easily calculated by using a graphic application software, such as Kleida Graph, a trade name).
Luminance=A+Bexp(−t/C)+Dexp(−t/E) (1)
wherein A to E each represents a constant, and t represents a period of time lapsing after the application of the direct current (DC) voltage of 1 V.

The measured data are fitted with the function, and the value on t=0 (i.e., A+B+C) is obtained from the result of the fitting and is designated as 100%.

Furthermore, the luminance before overlaying the direct current (DC) voltage is normalized to 0%. Under the conditions, the luminance on t=120 seconds is obtained.

(2) Change in Flicker Intensity upon Application of Direct Current

In this method, the susceptibility in relaxation of a direct current (DC) voltage is measured to evaluate the susceptibility in accumulation of a direct current (DC) voltage. The measured data is fitted with the following exponential equation (2) (which can be easily calculated by using a graphic application software, such as Kleida Graph, a trade name).
Luminance=A+Bexp(−t/C)+Dexp(−t/E) (2)
wherein A to E each represents a constant, and t represents a period of time lapsing after the application of the direct current (DC) voltage of 1 V.

The measured data are fitted with the function, and the value on t=0 (i.e., A+B+C) is obtained from the result of the fitting and is designated as 100%.

Furthermore, the flicker intensity before overlaying the direct current (DC) voltage is normalized to 0%. Under the conditions, the flicker intensity on t=120 seconds is obtained.

(3) Change in Luminance Immediately after Termination of Application of Direct Current

What is measured herein corresponds to an actual after image occurring after switching the displayed pattern. The measured data is fitted with the following exponential equation (3) (which can be easily calculated by using a graphic application software, such as Kleida Graph, a trade name).
Luminance=A+Bexp(−t/C)+Dexp(−t/E) (3)
wherein A to E each represents a constant, and t represents a period of time lapsing after the application of the direct current (DC) voltage of 1 V.

The measured data are fitted with the function, and the value on t=0 (i.e., A+B+C) is obtained from the result of the fitting and is designated as 100%.

Furthermore, the luminance before overlaying the direct current (DC) voltage is normalized to 0%. Under the conditions, the luminance on t=122 seconds is obtained.

(4) Change in Flicker Intensity during Application of Direct Current

What is measured herein corresponds to an actual after image occurring after switching the displayed image. The measured data is fitted with the following exponential equation (4) (which can be easily calculated by using a graphic application software, such as Kleida Graph, a trade name).
Luminance=A+Bexp(−t/C)+Dexp(−t/E) (4)
wherein A to E each represents a constant, and t represents a period of time lapsing after the application of the direct current (DC) voltage of 1 V.

The measured data are fitted with the function, and the value on t=0 (i.e., A+B+C) is obtained from the result of the fitting and is designated as 100%.

Furthermore, the flicker intensity before overlaying the direct current voltage is normalized to 0%. Under the conditions, the flicker intensity on t=122 seconds is obtained.

According to the measurements, firstly, it has been found by visual evaluation that with respect to the change in luminance upon application of a direct current (1), the characteristic feature necessary for suppressing an after image is that the increment of luminance after lapsing 120 seconds from application of a direct current voltage is 40% or more of the luminance immediately after the application of the direct current voltage.

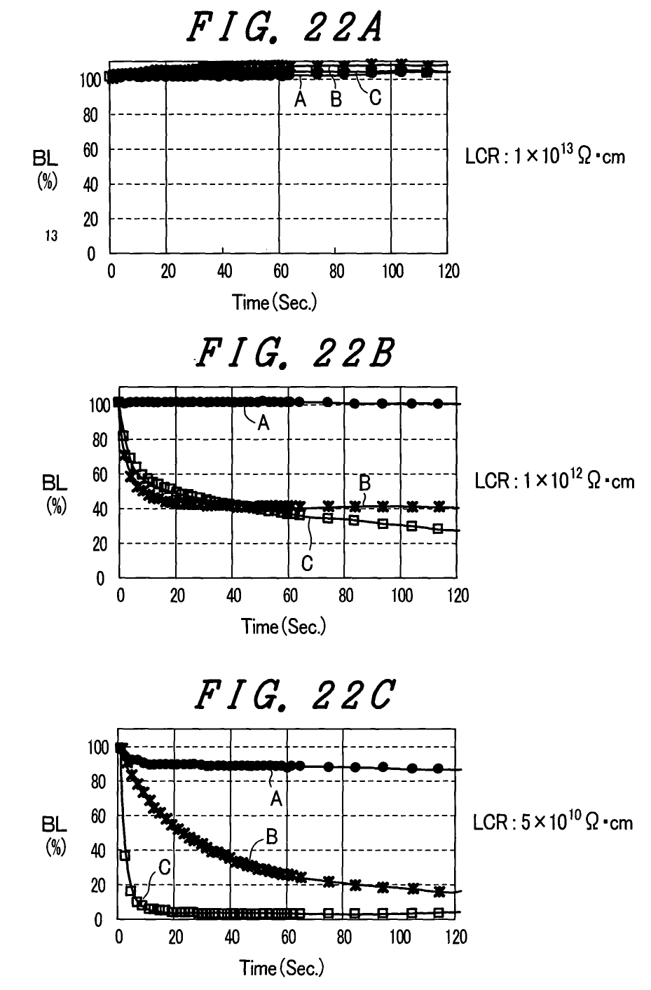

FIGS. 22A to 22C are enlarged views of a part of FIGS. 21A to 21C, respectively, where the direct current voltage is applied (in which the abscissa indicates the time of from 0 to 120 seconds).

The solid lines in FIGS. 22A to 22C are the lines fitted by the aforementioned method.

The figures shows that the orientation film A satisfies the condition, i.e., the increment of luminance after lapsing 120 seconds from application of a direct current (DC) voltage is 40% or more of the luminance immediately after the application of the direct current (DC) voltage, with any resistivity of the liquid crystal, and it has a low dependency on a resistivity of the liquid crystal and maintain a high value.

It has been found, on the other hand, that the orientation film B satisfies the condition with a resistively of the liquid crystal of 1×10¹² Ω·cm, but cannot satisfy the conditions with a resistivity of the liquid crystal less than that value. It is also found, furthermore, that the orientation film C cannot satisfy the condition even with a resistively of the liquid crystal of 1×10¹² Ω·cm.

As described in the foregoing, it has been demonstrated that the evaluation method can quantitatively determine the after image characteristics of the liquid crystal display device, and it has found that the orientation film A excellent in linearity shows a particular effect in suppressing an after image.

It has been found by visual evaluation that with respect to the change in flicker intensity upon application of a direct current (2), the characteristic feature necessary for suppressing an after image is that the relative flicker intensity after lapsing 120 seconds from application of a direct current voltage is 40% or more of the relative flicker intensity immediately after the application of the direct current voltage.

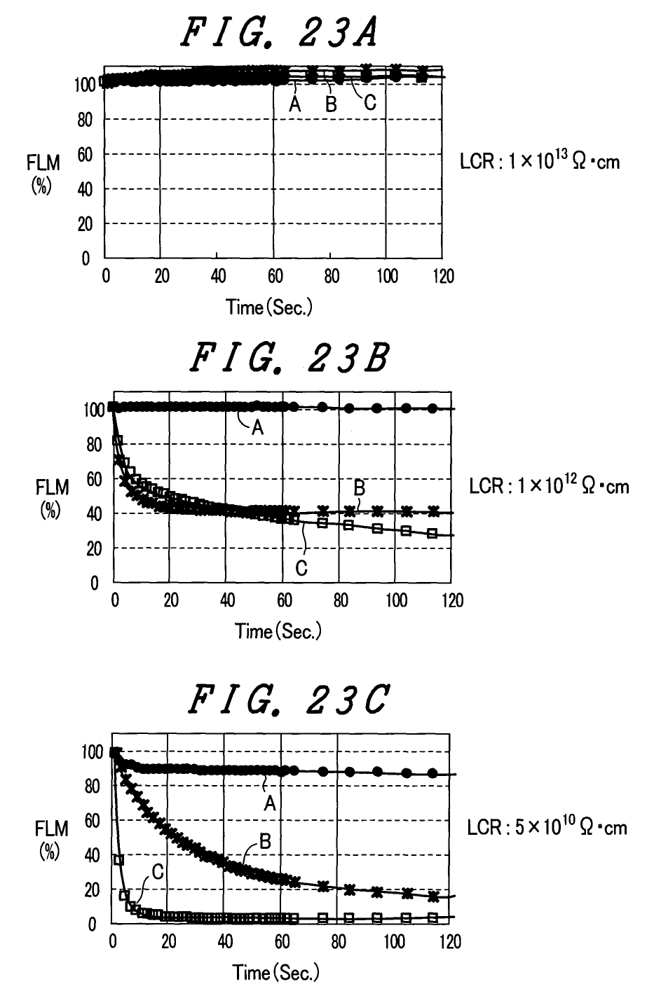

FIGS. 23A to 23C are enlarged views of a part of FIGS. 20A to 20C, respectively, where the direct current (DC) voltage is applied (in which the abscissa indicates the time of from 0 to 120 seconds).

The solid lines in FIGS. 23A to 23C are the lines fitted by the aforementioned method.

The figures show that the orientation film A satisfies the condition, i.e., the relative flicker intensity after lapsing 120 seconds from application of a direct current (DC) voltage is 40% or more of the luminance immediately after the application of the direct current (DC) voltage, with any resistivity of the liquid crystal LCR, and it has a low dependency on a resistivity of the liquid crystal and maintains a high value.

It has been found, on the other hand, that the orientation film B satisfies the condition with a resistively of the liquid crystal of 1×10¹² Ω·cm, but cannot satisfy the conditions with a resistivity of the liquid crystal less than that value. It is also found, furthermore, that the orientation film C cannot satisfy the condition even with a resistively of the liquid crystal of 1×10¹² Ω·cm.

As described in the foregoing, it has been demonstrated that the evaluation method can quantitatively determine the after image characteristics of the liquid crystal display device, and it has found that the orientation film A excellent in linearity shows a particular effect in suppressing an after image.

FIG. 24 is a graph showing the relationship of the relative luminance with respect to the resistivity of the liquid crystal of the respective orientation films A, B and C. In the figure, the abscissa indicates the resistivity of the liquid crystal LCR (Ω·cm), and the ordinate indicates the relative luminance BL(%).

It is apparent from the figure that the relative luminance BL has substantially no dependency on the resistivity of the liquid crystal LCR for the orientation film A, but it exhibits a strong dependency for the orientation films B and C, in which the value is decreased when the resistivity is lowered.

It is understood from the results that the orientation film A can be applied to a wide range of resistivity of a liquid crystal and can stably suppress an after image.

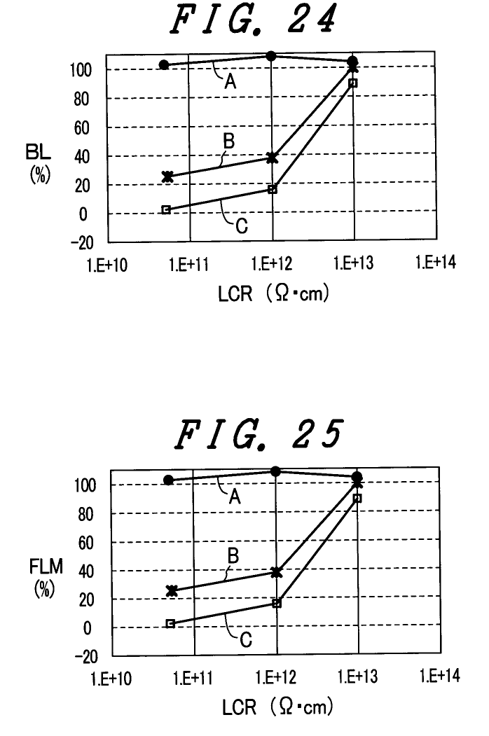

FIG. 25 is a graph showing the relationship of the relative flicker intensity with respect to the resistivity of the liquid crystal of the respective orientation films A, B and C. In the figure, the abscissa indicates the resistivity of the liquid crystal RLC (Ω·cm), and the ordinate indicates the relative flicker intensity (%).

It is apparent from the figure that the relative flicker intensity has substantially no dependency on the resistivity of the liquid crystal for the orientation film A, but it exhibits a strong dependency for the orientation films B and C, in which the value is decreased when the resistivity is lowered.

It is understood from the results that the orientation film A can be applied to a wide range of resistivity of a liquid crystal and can stably suppress an after image.

It has been found by visual evaluation that with respect to the change in luminance immediately after termination of the application of a direct current (3), the characteristic feature necessary for suppressing an after image is that the relative flicker intensity applying a direct current voltage (DC) for 120 seconds, followed by terminating the application of the direct current voltage (DC), and lapsing 2 seconds after the termination is 5% or less of the relative flicker intensity immediately after the application of the direct current (DC) voltage.

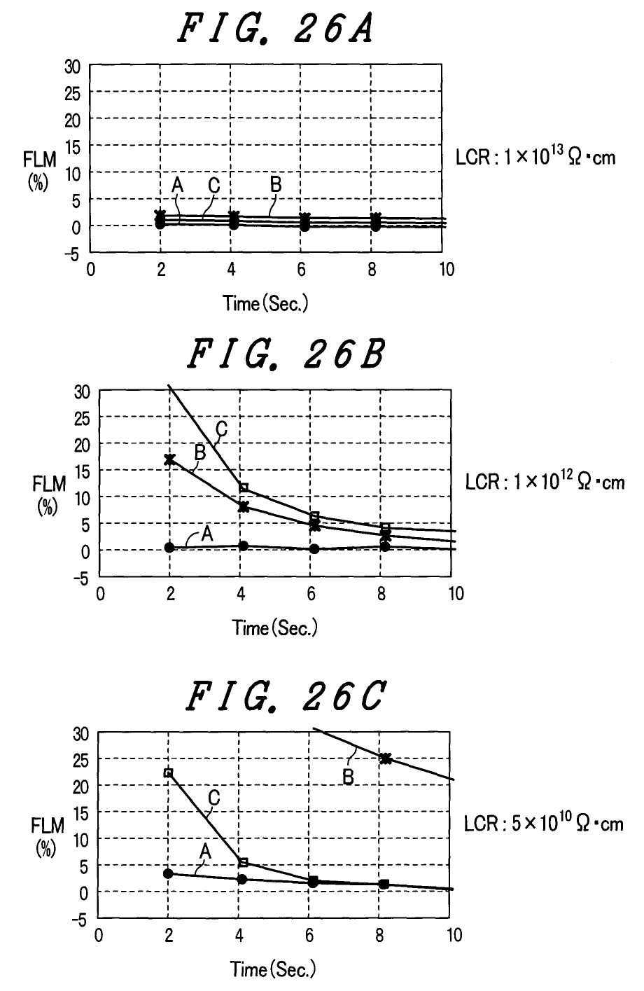

FIGS. 26A to 26C are enlarged views of a part of FIGS. 20A to 20C, respectively, where the direct current (DC) voltage is applied (in which the abscissa indicates the time after the termination of the direct current voltage of from 0 to 10 seconds).

It is apparent from the graph that the relative flicker intensity of the orientation film A becomes 5% or less after lapsing 2 seconds with any resistivity of the liquid crystal.

The time after lapsing 2 seconds is such a moment that the observer starts to recognize clearly an after image after switching the displayed image, and it has been found that in the case where an after image is suppressed to a level that cannot be visually recognized, it is difficult to be recognized as an after image by the observer.

It has also been found that the intensity that is recognized as an after image is a value corresponding to a relative flicker intensity of 5% or more.

It has been found that the orientation films B and C do not satisfy the value when the resistivity of the liquid crystal is 1×10¹² Ω·cm or less.

Furthermore, the orientation films B and C exhibits unstable behaviors as shown in FIGS. 26B and 26C, in which the relative flicker intensity is reversed. While the factor of the phenomenon has not yet been clarified, it is important for avoiding the instability that the relative flicker intensity is 5% or less after lapsing 2 seconds.

It has been found by visual evaluation that with respect to the change in relative flicker intensity during the application of a direct current (4), the characteristic feature necessary for suppressing an after image is that the relative luminance applying a direct current (DC) voltage for 120 seconds, followed by terminating the application of the direct current (DC) voltage, and lapsing 2 seconds after the termination is 5% or less of the relative luminance immediately after the application of the direct current (DC) voltage.

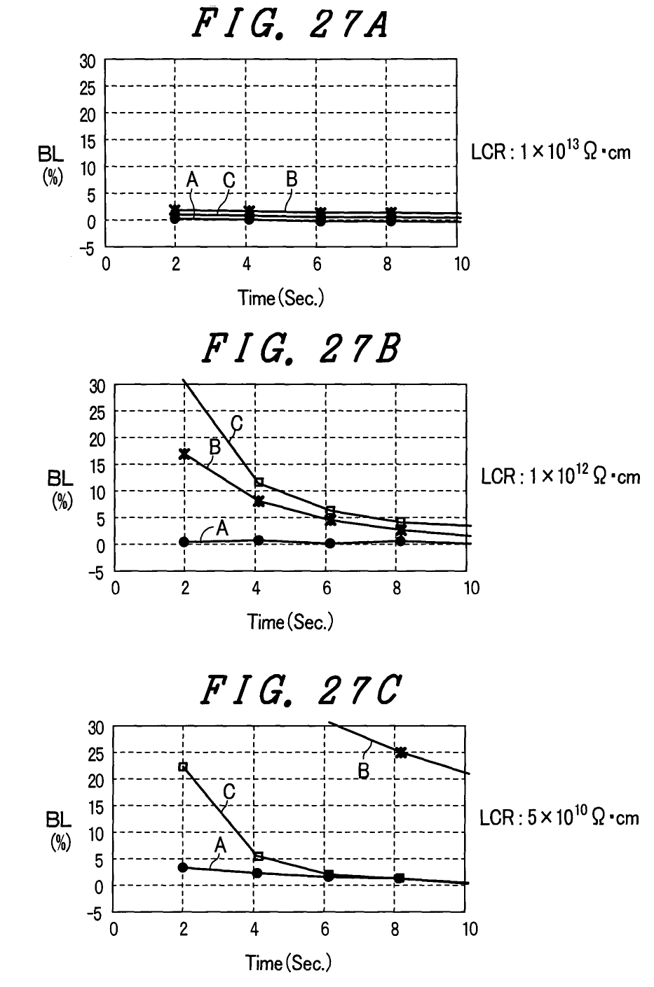

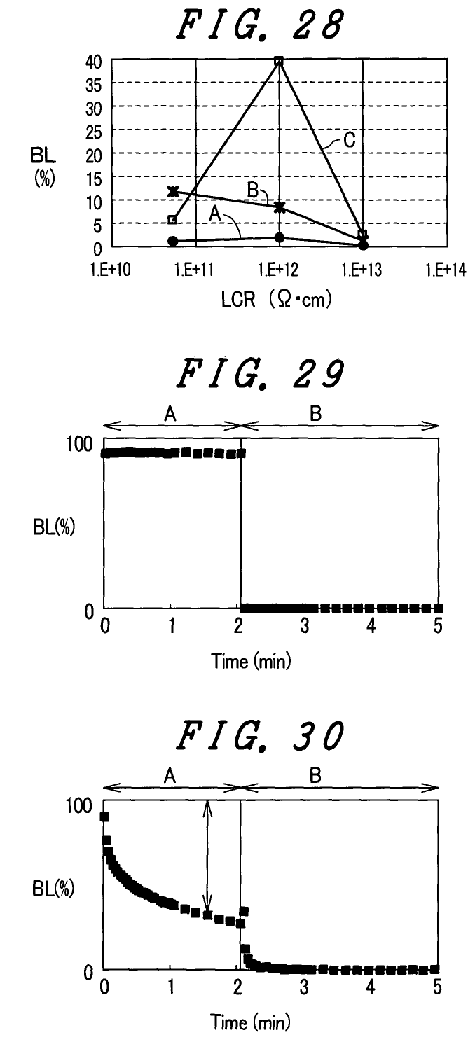

FIGS. 27A to 27C are enlarged views of a part of FIGS. 21A to 21C, respectively, where the direct current (DC) voltage is applied (in which the abscissa indicates the time after the termination of the direct current voltage of from 0 to 10 seconds).

It is apparent from the figure that the relative luminance of the orientation film A becomes 5% or less after lapsing 2 seconds with any resistivity of the liquid crystal.

The time after lapsing 2 seconds is such a moment that the observer starts to recognize clearly an after image after switching the displayed image, and it has been found that in the case where an after image is suppressed to a level that cannot be visually recognized, it is difficult to be recognized as an after image by the observer.

It has also been found that the intensity that is recognized as an after image is a value corresponding to a relative luminance of 5% or more.

It has been found that the orientation films B and C do not satisfy the value when the resistivity of the liquid crystal is 1×10¹² Ω·cm or less.

Furthermore, the orientation films B and C exhibit unstable behaviors as shown in FIGS. 27B and 27C, in which the relative luminance is reversed. Although the factor of the phenomenon has not yet been clarified, it is important for avoiding the instability that the relative luminance is 5% or less after lapsing 2 seconds.

FIG. 28 is a graph showing the dependency of the relative luminance on the resistivity of the liquid crystal after lapsing 2 seconds from the termination of the application of the direct current voltage in the cases where the orientation films A, B and C are used.

In the figure, the abscissa indicates the resistivity of the liquid crystal (Ω·cm), and the ordinate indicates the relative luminance (%).

It is understood from the graph that the orientation film A satisfies the conditions for stably suppressing an after image, but the orientation film B does not satisfy the conditions when the resistivity of the liquid crystal is lowered, and the orientation film C shows large fluctuation with respect to the resistivity of the liquid crystal.

It is also understood from the foregoing result that the orientation film A can stably suppress an after image.

The constitution of the pixel of the aforementioned liquid crystal display device is not construed as being limited to those shown in FIGS. 1 to 7, and various changes may be made on parts other than the essence of the invention.

As apparent from those having been described in detail, the liquid crystal display device according to the invention can significantly suppress occurrence of an after image.

1. A liquid crystal display device comprising substrates arranged as opposed to each other through a liquid crystal; a pixel electrode and a counter electrode for generating an electric field between the pixel electrode and the counter electrode, provided on a pixel region on a surface on a side of the liquid crystal of one of the substrates; and a charge transporting layer provided to cover the pixel electrode and the counter electrode,
wherein the pixel electrode and the counter electrode are formed in the same layer on one plane, and the liquid crystal have a resistivity of less than 1×10¹³ Ω·cm.

2. A liquid crystal display device as claimed in claim 1, wherein the charge transporting layer has a function of an orientation film.

3. A liquid crystal display device as claimed in claim 2, wherein the charge transporting layer which has a function of an orientation film has optical orientation property.

4. A liquid crystal display device as claimed in claim 1, wherein a starting material for forming the charge transporting layer contains a diamine.

5. A liquid crystal display device as claimed in claim 4, wherein a starting material for forming the charge transporting layer contains a phenylenediamine.

6. A liquid crystal display device as claimed in claim 4, wherein a starting material for forming the charge transporting layer contains cyclobutanetetracarboxylic dianhydride and a diamine.

7. A liquid crystal display device as claimed in claim 2, wherein the charge transporting layer has a resistivity that is equivalent to or smaller than a resistivity of the liquid crystal.

8. A liquid crystal display device comprising substrates arranged as opposed to each other through a liquid crystal; and a pixel electrode and a counter electrode for generating an electric field between the pixel electrode and the counter electrode formed in the same layer on one plane on a pixel region on a surface on a side of the liquid crystal of one of the substrates,
wherein a relative flicker intensity after lapsing 120 seconds from application of a direct current voltage between the pixel electrode and the counter electrode is 40% or more of a relative flicker intensity immediately after the application of the direct current voltage.

9. A liquid crystal display device comprising substrates arranged as opposed to each other through a liquid crystal; and a pixel electrode and a counter electrode for generating an electric field between the pixel electrode and the counter electrode formed in the same layer on one plane on a pixel region on a surface on a side of the liquid crystal of one of the substrates,
wherein an increment of luminance after lapsing 120 seconds from application of a direct current voltage between the pixel electrode and the counter electrode is 40% or more of an increment of luminance immediately after the application of the direct current voltage.

10. A liquid crystal display device comprising substrates arranged as opposed to each other through a liquid crystal; and a pixel electrode and a counter electrode for generating an electric field between the pixel electrode and the counter electrode formed in the same layer on one plane on a pixel region on a surface on a side of the liquid crystal of one of the substrates,
wherein a relative flicker intensity applying a direct current voltage between the pixel electrode and the counter electrode for 120 seconds, followed by terminating the application of the direct current voltage, and lapsing 2 seconds after the termination is 5% or less of a relative flicker intensity immediately after the application of the direct current voltage.

11. A liquid crystal display device comprising substrates arranged as opposed to each other through a liquid crystal; and a pixel electrode and a counter electrode for generating an electric field between the pixel electrode and the counter electrode formed in the same layer on one plane on a pixel region on a surface on a side of the liquid crystal of one of the substrates,
wherein an increment of luminance applying a direct current voltage between the pixel electrode and the counter electrode for 120 seconds, followed by terminating the application of the direct current voltage, and lapsing 2 seconds after the termination is 5% or less of an increment of luminance immediately after the application of the direct current voltage.

12. A liquid crystal display device as claimed in claim 8, wherein the liquid crystal display device further comprises a charge transporting layer formed to cover the pixel electrode and the counter electrode.

13. A liquid crystal display device as claimed in claim 8, wherein the liquid crystal has a resistivity of less than 1×10¹³ Ω·cm.

14. A liquid crystal display device as claimed in claim 12, wherein the charge transporting layer has a function of an orientation film.

15. A liquid crystal display device as claimed in claim 14, wherein the charge transporting layer is formed to cover directly the pixel electrode and the counter electrode.

16. A liquid crystal display device as claimed in claim 15, wherein a starting material for forming the charge transporting layer comprises a phenylenediamine.

17. A liquid crystal display device as claimed in claim 15, wherein a starting material for forming the charge transporting layer comprises cyclobutanetetracarboxylic dianhydride and a phenylene diamine as major components.

18. A liquid crystal display device as claimed in claim 2, wherein the charge transporting layer comprises the structure represented by the following general formula (1).

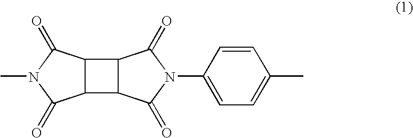

19. A liquid crystal display device as claimed in 8, wherein the charge transporting layer comprises the structure represented by the following general formula (2).

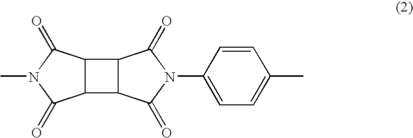

20. A liquid crystal display device as claimed in claim 1, wherein the charge transporting layer has optical orientation property.

21. A liquid crystal display device as claimed in claim 2, wherein a starting material for forming the charge transporting layer contains a phenylenediamine.

22. A liquid crystal display device as claimed in claim 2, wherein a starting material for forming the charge transporting layer contains a phenylenediamine.

23. A liquid crystal display device as claimed in claim 2, wherein a starting material for forming the charge transporting layer contains a diamine.

24. A liquid crystal display device as claimed in claim 3, wherein a starting material for forming the charge transporting layer contains a diamine.

25. A liquid crystal display device as claimed in claim 21, wherein a starting material for forming the charge transporting layer contains cyclobutanetetracarboxylic dianhydride and a diamine.

26. A liquid crystal display device as claimed in claim 22, wherein a starting material for forming the charge transporting layer contains cyclobutanetetracarboxylic dianhydride and a diamine.

27. A liquid crystal display device as claimed in claim 9, wherein the liquid crystal display device further comprises a charge transporting layer formed to cover the pixel electrode and the counter electrode.

28. A liquid crystal display device as claimed in claim 10, wherein the liquid crystal display device further comprises a charge transporting layer formed to cover the pixel electrode and the counter electrode.

29. A liquid crystal display device as claimed in claim 11, wherein the liquid crystal display device further comprises a charge transporting layer formed to cover the pixel electrode and the counter electrode.

30. A liquid crystal display device as claimed in claim 9, wherein the liquid crystal has a resistivity of less than 1×10¹³ Ω·cm.

31. A liquid crystal display device as claimed in claim 10, wherein the liquid crystal has a resistivity of less than 1×10¹³ Ω·cm.

32. A liquid crystal display device as claimed in claim 11, wherein the liquid crystal has a resistivity of less than 1×10¹³ Ω·cm.
